(19) United States
(12) Patent Application Publication
(10) Pub. No.: US 2018/0296932 A1
(43) Pub. Date: Oct. 18, 2018

(54) Amusement ride assembly with rotating tube and synchronized animation projector

(71) Applicant: Zhiwei Cao, San Jose, CA (US)

(72) Inventor: Zhiwei Cao, San Jose, CA (US)

(21) Appl. No.: 15/980,185

(22) Filed: May 15, 2018

(51) Int. Cl. A63G 31/16; G09B 19/00

(52) U.S. Cl. CPC A63G 31/16; G09B 19/0038

(57) ABSTRACT

This invention is an amusement apparatus. In particular, a player can ride a rolling toy, for example, a bicycle or a scooter, inside a rotating tube, so the riding is emulated. The player holds controlling devices, which control the rotation speed. A multi-functional digital module is installed statically inside the tube. It can detect player's position, receive control signal, and project synchronized 3D animation in front of the player, so a virtual 3D animation is presented.

### BACKGROUND OF THE INVENTION

Learning how to ride a bicycle is always hard for kids. On the other side, teaching how to ride a bicycle is also a headache to their parents. The root problem is the conflicts among power, balance and safety. If the power is from the kid's riding, the bicycle will move very low because kids are commonly not strong, and it will be very hard for the kid to keep balance at the same time. If the power is from the parent's pushing, the kid can be easily confused about the balance, and the speed raises the risk of injury. A good way to keep balance and safety is the kid leaving both his/her feet on the ground, but it will increase the resistance and lower the speed.

This invention can solve these conflicts. If the kid rides the bicycle inside a rotating tube, and controls rotation speed with controllers installed on the bicycle's handlebar, power can be easily gained and controlled. When the tube rotates, riding can be emulated vividly. During the riding, the kid can leave his/her feet on the tube's internal surface, so balance can be kept well, and the kid can increase the speed, try to pull up their feet and learn the handling gradually. If the kid losses the balance and falls off, he or she will stop holding the handles, and the switch on the handle will be triggered, then power will be cut off and brakes will be enabled, and the tube will stop rotating immediately. The result is the kid falls on a static tube, and the risk of injury is minimized.

To make the experience more educational and amusing, a digital projector is installed inside the tube, and a 3D animation synchronized with both the rotation of the tube and the position of the player is projected in front of the player, so a virtual 3D scenario, in which the player feels he or she is riding, can be seen through the 3D glasses worn on the player's face

Besides a bicycle, this invention can also be applied to a tricycle, a 3-wheel glider, a 2-wheel scooter, a skateboard and other rolling toys, to meet demands from kids across ages.

### SUMMARY OF THE INVENTION

This invention is an amusement apparatus, which includes a powered rotating tube, in which a player can ride a rolling toy, for example, a bicycle or a scooter, so the riding is emulated. The player holds hands-on controllers, which control the rotation speed. A multi-functional digital module is installed statically inside the tube. It can sense the player's position, receive control signal from the controllers, play sound and project a 3D animation, which is synchronized with the rotation of the tube and the position of the player, in front of the player, so a virtual 3D scenario is presented.

### BRIEF DESCRIPTION OF THE DRAWINGS

FIG. 1 is a perspective view from the front end of the ride assembly, which is at working status.

FIG. 2 is a perspective view from the left side of the ride assembly, with the tube partially broken away to show the internal details.

FIG. 3 is a perspective view of the specially shaped static frame.

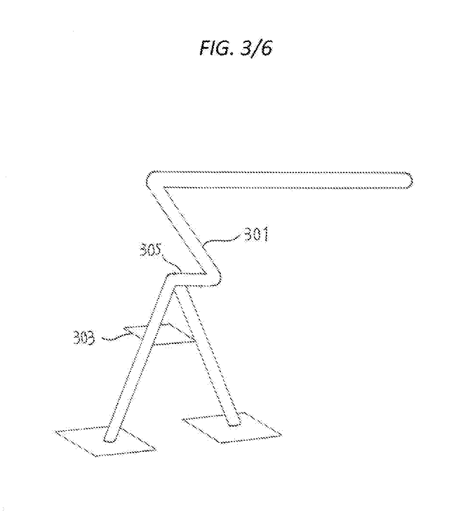

FIG. 4 illustrates the specially shaped main bearing.

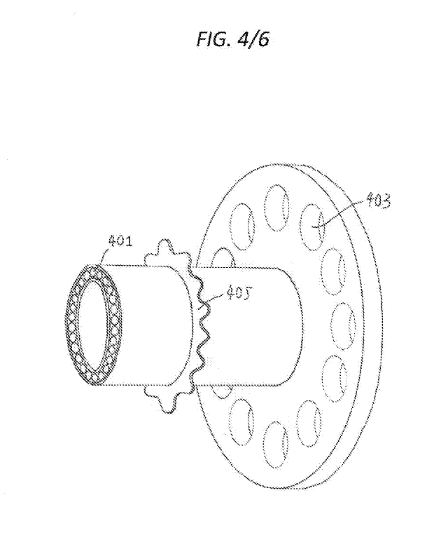

FIG. 5 illustrates the spoke and spoke pillar cap, which are used to connect the tube and the main bearing.

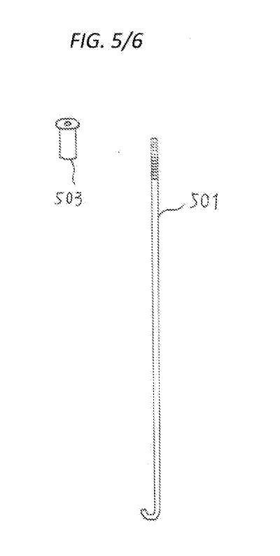

FIG. 6 illustrates a handlebar, which is also a remote controller of the tube.

### DETAILED DESCRIPTION OF THE INVENTION

The present invention is an apparatus ride assembly, in which a player can ride a rolling toy, for example, a bicycle.

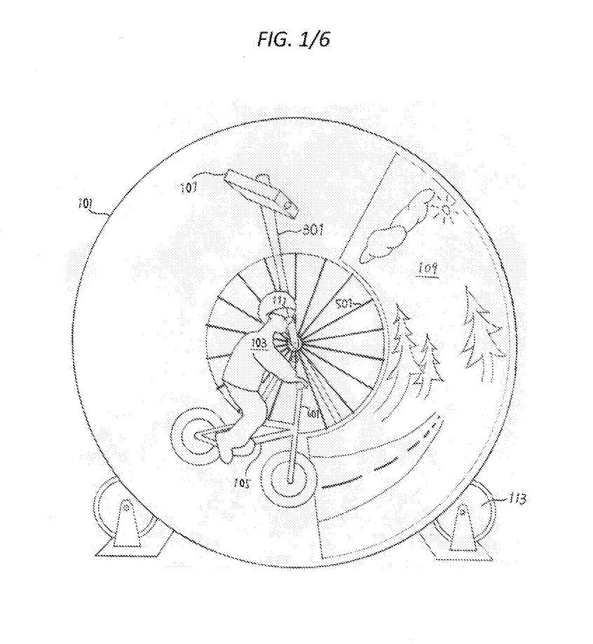

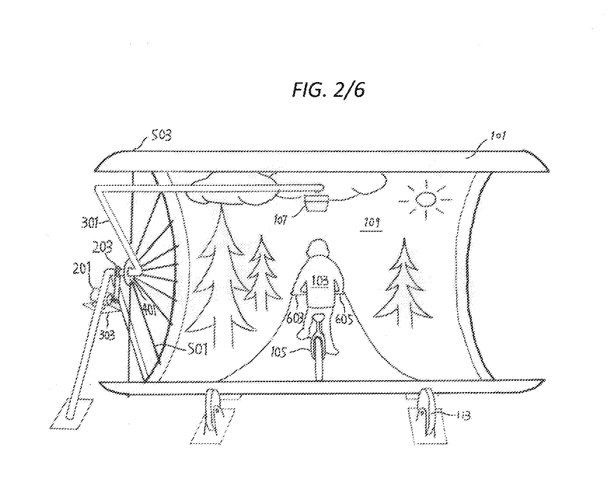

The tube 101 illustrated in FIG. 1 and FIG. 2 can be powered to rotate, so because of gravity, the player 103 on the bicycle 105 can emulate riding inside the tube 101 endlessly without stamping the pedals. The multi-functional digital module 107, hanging on the static frame 301 as illustrated in FIG. 1 and FIG. 2, has a fixed position inside the tube 101. It receives rotation speed signal from the axle 305, senses the player 103′s position through its radar sensor and camera, plays sound and projects three dimensional animation 109, which is synchronized with the tube 101′s rotation speed and the player 103′s position, on the internal surface of the tube 101. Through the three dimensional glasses 111, the player 103 can see a three dimensional real-time virtual scenario around him/her, and feel he or she is riding inside the scenario vividly. The tube 101 is supported by the wheels 113 beneath it. The wheels 113 contain brakes, which are controlled by the multi-functional digital module 107.

A static frame 301 is installed by the back side of the tube 101 as illustrated in FIG. 1 and FIG. 2. A motor 201 is installed on the motor platform 303. The main bearing 401 is installed on the axle 305. A linked metal circle chain 203 is used to connect the motor 201 and the main bearing 401 by circling on both the sprocket 405 on the main bearing 401 and the sprocket on the motor, so the motor 201 can drive the main bearing 401 to rotate. The spokes 501 are used to connect the tube 101 and the main bearing 401. The hook end of a spoke 501 hooks through one of the holes 403 on the main bearing 401, and the screw end of a spoke 501 screws in the spoke pillar cap 503. The spoke pillar caps 503 insert through the holes equally spreaded on the back rim of the tube 101 from outside. After screwing the spoke pillar caps 503 properly, spokes 501 are fastened, and the tube 101 is fixed horizontally. At the same time, the tube 101 can be driven to rotate by the main bearing 401, and by the motor 201 indirectly.

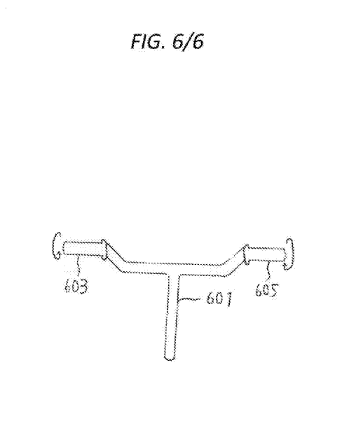

The handlebar 601 illustrated in FIG. 6 is also a remote controller connecting with the multi-functional digital module 107 wirelessly, and it can be installed on multiple kinds of rolling toys, like bicycle, tricycle, 3-wheel glider and 2-wheel scooter. The left handle 603 can be rotated with elastic resistance and send wireless signal to the multi-functional digital module 107. When it's rotated by the player 103 in a small angle and reaches the rotation end, a signal is sent to the multi-functional digital module 107, saying that the motor 201 can be turned on, then the multi-functional digital module 107 connects the motor 201 with power and puts it into ready status. When it's released by the player 103, the elastic force inside it will resume it to its initial position and send a signal to the multi-functional digital module 107, saying that the tube 101 should be stopped, then the multi-functional digital module 107 will cut off the power of the motor 201 and enable the brakes on the wheels 113, then the tube will be stopped immediately. The right handle 605 can also be rotated with elastic resistance and send wireless signal to the multi-functional digital module 107. It constantly sends rotation degree signal to the multi-functional digital module 107. The more this handle 605 is rotated means the faster the player 103 wants. The multi-functional digital module 107 adjusts the power of the motor 201 accordingly, so the rotation speed of the tube 101 is adjusted as well.

What is claimed is:

1. An amusement apparatus for emulating riding a rolling toy in a synchronized 3D scenario. It contains
a player;
a rolling toy, which can be a bicycle, a tricycle, a 3-wheel glider, a 2-wheel scooter or a skateboard;
a powered rotating tube;
a multi-functional digital module;
means for said player emulating riding said rolling toy, in a manner that said player riding said rolling toy inside said powered rotating tube;
means for presenting said synchronized 3D scenario by installing said multi-functional digital module inside said rotating tube, and letting said multi-functional digital module play sound and project 3D animation, which is seen through a pair of 3D glasses, in front of said player;

2. The apparatus of claim 1, wherein said means for said player emulating riding said rolling toy further includes means for said player controlling said powered rotating tube, in a manner that installs remote controllers on said rolling toy's handlebar, and enables player to remotely control the speed of said powered rotating tube by rotating the handles and letting motor and brakes behave accordingly.

3. The apparatus of claim 1, wherein said means for presenting said synchronized 3D scenario further includes means for detecting and synchronizing said player's position and said powered rotating tube's speed, in the manner that lets said multi-functional digital module use its radar detector and camera to detect said player's position, use its wired signal receiver to receive said powered rotating tube's speed, process with its central processor and synchronize with 3D scenario generation.

4. The apparatus of claim 1, wherein said means for presenting said synchronized 3D scenario further includes means for installing said multi-functional digital module at a fixed position inside said powered rotating tube, in the manner that installs a specially shaped static frame, on which said multi-functional digital module is installed.

5. The apparatus of claim 1, wherein said multi-functional digital module integrates digital optical projector, audio player, radar detector, camera, wired signal receiver, wireless signal receiver and central processor.
